(19) United States
(12) Patent Application Publication
(10) Pub. No.: US 2019/0012348 A1
(43) Pub. Date: Jan. 10, 2019

(54) DATA AGGREGATION METHOD AND DEVICE

(71) Applicant: ALIBABA GROUP HOLDING LIMITED, George Town (KY)

(72) Inventor: Julei LI, Hangzhou (CN)

(73) Assignee: ALIBABA GROUP HOLDING LIMITED

(21) Appl. No.: 16/131,872

(22) Filed: Sep. 14, 2018

Related U.S. Application Data
(63) Continuation of application No. PCT/CN2017/075069, filed on Feb. 27, 2017.

(30) Foreign Application Priority Data
Mar. 15, 2016 (CN) 201610147522.3

(51) Int. Cl. G06F 17/30

(52) U.S. Cl. CPC G06F 17/30489; G06F 17/3048

(57) ABSTRACT

The present disclosure discloses data aggregation methods and apparatuses. According to some embodiments of the present disclosure, when massive service data stored in a cloud environment needs to be aggregated, a data aggregation server first receives service data sent by a service data server. It can be detected in real time whether a time stamp carried in the service data is greater than a time stamp carried in service data that is received by the data aggregation server at a previous time. If so, data aggregation can be performed on service data having a time stamp that is the same as the time stamp carried in the service data that is received by the data aggregation server at the previous time. That way, precision and efficiency of data aggregation can be improved. Further, the real-time performance of data aggregation can be ensured.

This application claims priority to International Application No. PCT/CN2017/075069, filed on Feb. 27, 2017, which claims priority to and the benefits of priority to Chinese Application No. 201610147522.3, filed on Mar. 15, 2016, both of which are incorporated herein by reference in their entireties.

### TECHNICAL FIELD

The present disclosure relates to the field of information technology, and in particular, to data aggregation methods and apparatuses.

### BACKGROUND

With the constant development of the Internet, it has become increasingly popular to store and collect service data in a cloud environment, for example, to store and collect different types of service data such as queries per second (QPS) data and page view (PV) data. Moreover, a huge amount of data is stored in the cloud environment. Massive service data stored in the cloud environment may need to be aggregated before statistics of the data is collected and analyzed.

In existing techniques, during the aggregation process of the massive service data stored in the cloud environment, various types of service data received during different time periods are first written into files. Service data of a certain type that needs to be aggregated is then read from the files. The read service data is then sorted in a chronological order and sent to a computing server for aggregation. For example, the service data can be sent to a MapReduce server for data aggregation.

However, based on such techniques, read/write operations need to be performed on the files during data aggregation. To address file locking conflicts associated with the read/write operations on the files, during data aggregation, a file copying process is performed to save the data that need to be aggregated. As a result, there is a relatively long delay in data computation. Moreover, service data read from the files further needs to be sorted in a chronological order. Consequently, the process of data aggregation is relatively complex, data aggregation operations have relatively low efficiency, and the data aggregation operations have a relatively high delay. In addition, after service data is read from the files and an aggregation operation is completed, if service data associated with the same time as or a time earlier than that of the service data on which the aggregation operation is performed is received, this part of service data may be discarded. As a result, the precision of data aggregation and statistical analysis is compromised.

### SUMMARY

In view of the above problems, the present disclosure provides data aggregation methods and apparatuses. One objective of the present disclosure is to address the technical problem of high latency in data aggregation operations where massive service data stored in a cloud environment is involved. Another objective of the present disclosure is to address the technical problem of low precision of data aggregation and statistical analysis.

According to some embodiments of the present disclosure, data aggregation methods are provided. One exemplary method comprises: receiving, by a data aggregation server, service data sent by a service data server, the service data carrying a time stamp, and the time stamp being used to identify the time at which the service server receives the service data; detecting whether the time stamp is greater than a target time stamp, the target time stamp being a time stamp carried in service data that is sent by the service data server and is received by the data aggregation server at a previous time; and performing, if the time stamp is greater than the target time stamp, data aggregation on service data having a time stamp that corresponds to the target time stamp. The service data corresponding to the target time stamp can be stored at a preset storage location.

According to some embodiments of the present disclosure, data aggregation apparatuses are provided. One exemplary apparatus comprises: a receiving unit configured to receive service data sent by a service data server, the service data carrying a time stamp, and the time stamp being used to identify the time at which the service server receives the service data; a detection unit configured to detect whether the time stamp received by the receiving unit is greater than a target time stamp, the target time stamp being a time stamp carried in service data that is sent by the service data server and is received at a previous time; and an aggregation unit configured to perform, if the time stamp detected by the detection unit is greater than the target time stamp, data aggregation on service data having a time stamp that corresponds to the target time stamp. The service data corresponding to the target time stamp can be stored at a preset storage location.

The foregoing technical solutions according to some embodiments of the present disclosure have at least the following advantages. With the data aggregation methods and apparatuses provided in the present disclosure, when massive service data stored in a cloud environment needs to be aggregated, a data aggregation server first receives service data sent by a service data server. It can then be detected in real time whether a time stamp carried in the service data is greater than a time stamp carried in service data that is sent by the service data server and is received by the data aggregation server at a previous time. If the time stamp carried in the service data is greater than a time stamp carried in service data that is sent by the service data server and is received by the data aggregation server at a previous time, data aggregation is performed on service data having a time stamp that is the same as the time stamp carried in the service data that is sent by the service data server and is received by the data aggregation server at the previous time.

In existing techniques, during the process of aggregating massive service data stored in the cloud environment, read/write operations need to be performed on files storing service data. The read service data further needs to be sorted in a chronological order. If service data associated with the same time as or a time earlier than that of service data on which an aggregation operation is performed is received, this part of service data will be discarded.

According to some embodiments of the present disclosure, to aggregate service data in different time periods, it can be detected whether a time stamp of currently received service data is greater than the time stamp carried in the service data that is sent by the service data server and is received by the data aggregation server at a previous time. That way, the efficiency of data aggregation can be improved. Because the detection operation can be performed in real time, a delay of data aggregation operations can be reduced, and the real-time performance of data aggregation can be improved. Moreover, a tolerance time period can be set, an aggregation operation can be performed on service data that are associated with an earlier time, so that the precision of data aggregation and statistical analysis can be improved.

The foregoing description is only a brief introduction of some exemplary technical solutions of the present disclosure. To facilitate better understanding of the technical solutions, features, and advantages of embodiments of the present disclosure, detailed description of some exemplary embodiments are further provided below.

### BRIEF DESCRIPTION OF THE DRAWINGS

Exemplary embodiments provided in the present disclosure, and advantages and benefits thereof, will be further described below. It is appreciated that the accompanying drawings are only used for the purpose of showing some exemplary implementation manners and are not intended to limit the present disclosure. Further, the same or similar reference numerals may be used to represent the same or similar components in the accompanying drawings. In the accompanying drawings:

FIG. 1 is a flowchart of an exemplary data aggregation method according to some embodiments of the present disclosure.

FIG. 2 is a flowchart of an exemplary data aggregation method according to some embodiments of the present disclosure.

FIG. 3 is a schematic structural diagram of an exemplary data aggregation apparatus according to some embodiments of the present disclosure.

FIG. 4 is a schematic structural diagram of an exemplary data aggregation apparatus according to some embodiments of the present disclosure.

FIG. 5 is a schematic diagram illustrating an existing data aggregation procedure.

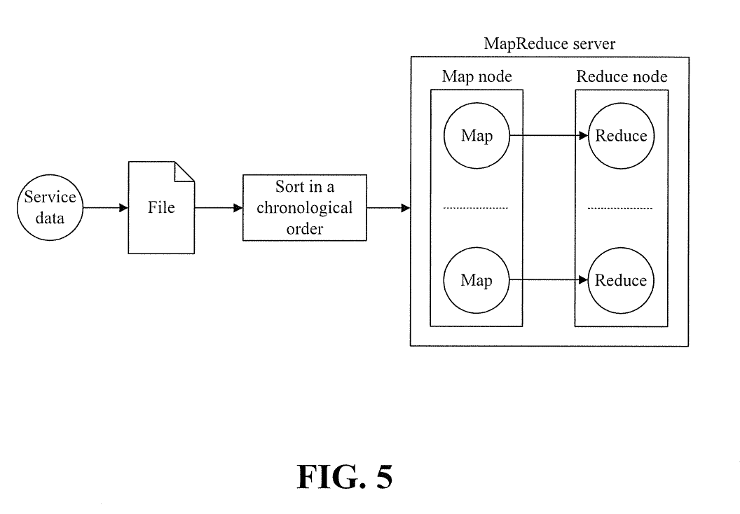

FIG. 6 is a schematic diagram illustrating exemplary time stamps of service data in different service data servers according to some embodiments of the present disclosure.

FIG. 7 is a schematic diagram illustrating exemplary local times of different data aggregation servers according to some embodiments of the present disclosure.

FIG. 8 is a schematic diagram illustrating exemplary time stamps of different service data in a data aggregation server according to some embodiments of the present disclosure.

FIG. 9 is a schematic diagram of an exemplary mapping implementation between a time of a service data server and a time of a data aggregation server according to some embodiments of the present disclosure.

### DETAILED DESCRIPTION

Exemplary embodiments of the present disclosure are described below in further detail with reference to the accompanying drawings. Although exemplary embodiments of the present disclosure are shown in the accompanying drawings, it should be appreciated that the present disclosure may be implemented in various forms and are not limited by the embodiments described herein. The embodiments described herein are examples provided for a better understanding of the technical solutions provided in the present disclosure.

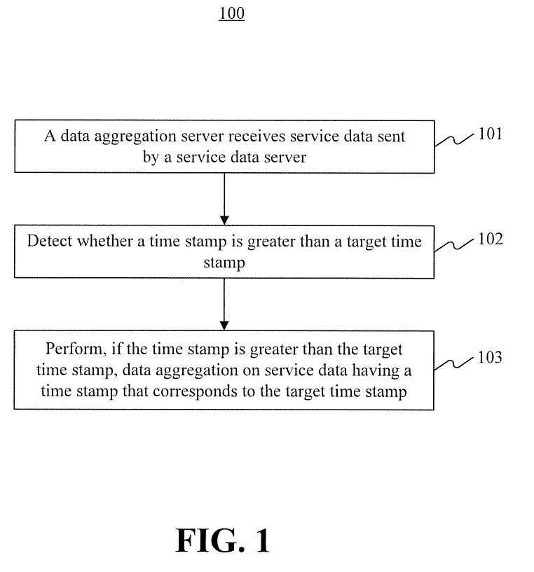

According to some embodiments of the present disclosure, data aggregation methods are provided. As shown in FIG. 1, an exemplary data aggregation method 100 can include the following procedures.

In step 101, a data aggregation server receives service data sent by a service data server. The service data can carry a time stamp. The time stamp can be used to identify the time at which the service server receives the service data. For example, if the time at which the service data server receives the service data is 10:01, a time stamp carried in the service data received by the data aggregation server is 10:01. The data aggregation server can be configured to perform aggregation processing on the service data sent by the service data server. The service data may be different types of service data such as QPS data and PV data. The service data may also be the same type of service data associated with different applications, for example, PV data of an application A and an application B. The types of service data are not limited by the embodiments described herein.

In step 102, it can be detected whether the time stamp is greater than a target time stamp. The target time stamp can be a time stamp carried in service data that is sent by the service data server and is received by the data aggregation server at a previous time. Different time stamps may be presented in a chronological order such as a list and a time axis, the implementation of which is not limited by the embodiments described herein. For example, when different time stamps are presented in a chronological order such as a time axis, the time indicated on the time axis keeps rolling forward and indicates the current time point. In some embodiments, it can be detected whether the time stamp is greater than the target time stamp. That is, it can be detected whether the time of the currently received service data differs from the time of service data received at a previous time. Based on the detection result, it can be determined whether to trigger a service data aggregation operation, so that the real-time performance of the service data aggregation operation can be ensured.

In some embodiments, the time stamps may be configured by using a second as a unit or by using a minute as a unit. Other units may be used. The actual implementation is not limited by the embodiments described herein. In cases where the time stamps are configured by using a second as a unit, different time stamps are distinguished by seconds, for example, 10:01:01, 10:01:02, and 10:01:03. Similarly, the time stamps can be configured by using a minute as a unit. Different time stamps can be distinguished by minutes, for example, 10:01, 10:02, and 10:03. In that case, 10:01:01 to 10:01:59 can all be considered as corresponding to 10:01. Such implementation can be similarly applied in other embodiments using different units.

As an example, the service data server can configure the time stamps by using a minute as a unit. If a time stamp carried in service data that is sent by the service data server and is currently received by the data aggregation server is 10:01, and a time stamp carried in service data that is sent by the service data server and is received by the data aggregation server at a previous time is also 10:01, it can be determined that the service data aggregation operation is not triggered. If a time stamp carried in service data that is sent by the service data server and is currently received by the data aggregation server is 10:02, which is greater than the time stamp 10:01 carried in the service data that is sent by the service data server and received by the data aggregation server at the previous time, it can be determined that the service data aggregation operation is to be triggered.

In step 103, if the time stamp is greater than the target time stamp, data aggregation is performed on service data having a time stamp that corresponds to the target time stamp. The service data corresponding to the target time stamp can be stored at a preset storage location. The preset storage location may be in the form of a preset mapping relationship table, a preset queue, or the like. The storage manners are not limited by the embodiments described herein.

If the time stamp is greater than the target time stamp, for example, changing from 10:01 to 10:02, or changing from 10:01:01 to 10:01:02, it indicates that a time stamp carried in current service data changes forward. It can trigger in real time performance of an aggregation operation on all service data having the previous time stamp. That way, real-time performance of a service data aggregation operation can be ensured, and the efficiency of service data aggregation can be improved.

According to the above data aggregation methods, when massive service data stored in a cloud environment needs to be aggregated, a data aggregation server first receives service data sent by a service data server. It can then be detected in real time whether a time stamp carried in the service data is greater than a time stamp carried in service data that is sent by the service data server and is received by the data aggregation server at a previous time. If the time stamp carried in the service data is greater than a time stamp carried in service data that is sent by the service data server and is received by the data aggregation server at the previous time, data aggregation can be performed on service data having a time stamp that is the same as the time stamp carried in the service data that is sent by the service data server and is received by the data aggregation server at the previous time.

In existing techniques, during the process of aggregating massive service data stored in the cloud environment, read/write operations need to be performed on the files storing service data. The read service data further needs to be sorted in a chronological order. In comparison, according to the data aggregation methods provided herein, to aggregate service data in different time periods, it can be detected whether a time stamp of current service data is greater than the time stamp carried in the service data that is sent by the service data server and is received by the data aggregation server at a previous time. so that the efficiency of data aggregation can be improved. Because the detection operation can be performed in real time, a delay of data aggregation operations can be reduced. The real-time performance of data aggregation can be improved.

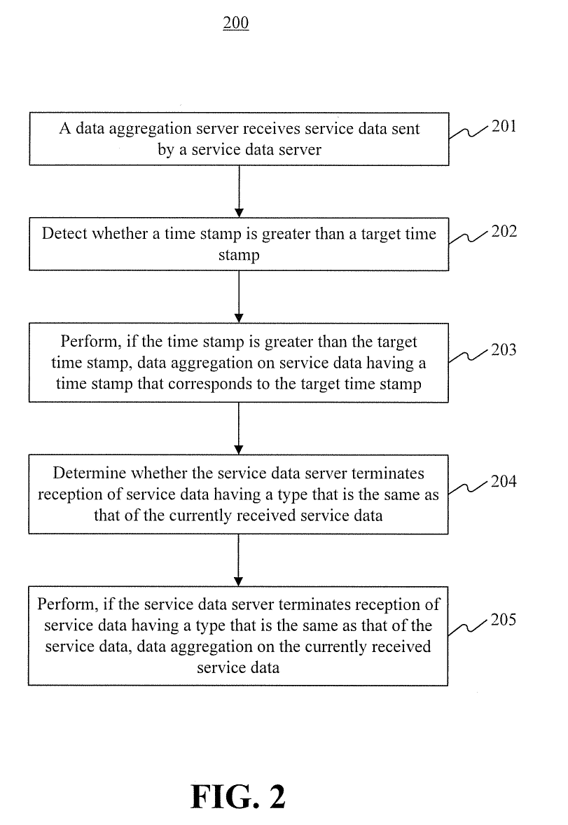

FIG. 2 is a flowchart of an exemplary data aggregation method 200 according to some embodiments of the present disclosure. As shown in FIG. 2, the exemplary method 200 includes the following procedures.

In step 201, data aggregation server receives service data sent by a service data server. The service data carries a time stamp. The time stamp can be used to identify the time at which the service server receives the service data. For the corresponding description of the data aggregation server and the service data, reference can be made to the corresponding description above with respect to FIG. 1, details of which are not repeated herein.

In step 202, it can be detected whether the time stamp is greater than a target time stamp. The target time stamp can be a time stamp carried in service data that is sent by the service data server and is received by the data aggregation server at a previous time. For details relating to configuration of the time stamp, reference can be made to the corresponding description above with respect to FIG. 1.

In some embodiments, it can be detected whether the time stamp is greater than the target time stamp. That is, it can be detected whether the current time of receiving service data changes forward from the time of receiving service data at a previous time. It can then be determined whether to trigger a service data aggregation operation, so that the real-time performance of the service data aggregation operation can be ensured.

Further, in some embodiments, after step 202, the method may further include: caching, if the time stamp is the same as the target time stamp, the currently received service data in a preset queue corresponding to the target time stamp. All service data having a time stamp that corresponds to the target time stamp can be cached in the preset queue. Service data having different time can be respectively cached in different preset queues. Because caching and reading operations on queues have a relatively low delay, delays associated with data aggregation operations can further be reduced by caching service data in queues. That way, real-time performance of data aggregation operations can be improved. If the time stamp is less than the target time stamp, the currently received service data can be deleted. For example, the time stamp changes from 10:01 to 09:50, the currently received service data having a time stamp of 09:50 can be deleted, so that the accuracy of data aggregation can be ensured.

In step 203, if the time stamp is greater than the target time stamp, data aggregation is performed on service data having a time stamp that corresponds to the target time stamp. The service data corresponding to the target time stamp can be stored at a preset storage location. The preset storage location may include a preset mapping relationship table, a preset queue, or the like. The actual implementation is not limited by the embodiments disclosed herein.

In some embodiments, before step 203, the method may further include: determining whether service data having a time stamp that corresponds to the target time stamp is received within a first preset time period after the currently received service data. It is appreciated that, after service data having a certain time stamp is aggregated, for reasons such as a delay in data transmission, the service data server may receive service data having the same time stamp. In this case, if the service data received after a delay is not processed, it may cause loss of service data. And as a result, the accuracy of service data aggregation may be compromised. Therefore, before data aggregation is performed, a tolerance time period can be configured. For example, here a first preset time period can be configured. The loss of service data that is received after a delay can be avoided, and the accuracy of service data aggregation and statistical analysis can be improved.

The first preset time period can be configured according to a configuration unit of a time stamp. For example, if the configuration unit of the time stamp is a second, the first preset time period may be 1 second, 2 seconds, or the like. If the configuration unit of the time stamp is a minute, the first preset time period may be 1 minute, 2 minutes, or the like. By configuring the first preset time period according to the configuration unit of the time stamp, the accuracy of configuring a tolerance time period can be improved. Accordingly, the accuracy of service data aggregation can further be improved.

In some embodiments, step 203 can further include: performing, if no service data having a time stamp that corresponds to the target time stamp is received within the first preset time period, data aggregation on service data having a time stamp that corresponds to the target time stamp; and performing, if service data having a time stamp that corresponds to the target time stamp is received within the first preset time period, data aggregation on the service data received within the first preset time period and service data having a time stamp that corresponds to the target time stamp.

For example, the service data server configures the time stamps by using a minute as a unit. In this case, the first preset time period can be configured to be 5 minutes. A time stamp carried in service data that is sent by the service data server and is currently received by the data aggregation server is 10:02 and a time stamp carried in service data that is sent by the service data server and is received by the data aggregation server at a previous time is 10:01. Before the service data having a time stamp of 10:01 is aggregated, it can be determined whether service data carrying a time stamp of 10:01 is received within five minutes starting from the current time. If such service data is received within the five minutes, data aggregation is performed on the service data that is received within the five minutes and has a time stamp of 10:01, along with the service data that is received before and has a time stamp of 10:01. If no such service data is received within the five minutes, it indicates that there is no delayed service data at this time, and data aggregation is performed on the service data having a time stamp of 10:01, so that the accuracy of data aggregation can be ensured. In some embodiments, after step 203, the method may further include: establishing a queue corresponding to a time stamp of currently received service data; and caching the service data in the queue. Different time stamps can correspond to different queues. A new queue can be created to store the currently received service data.

In step 204, it can be determined whether the service data server terminates reception of service data having a type that is the same as that of the currently received service data. In some embodiments, service data having the same type may be service data having the same service data type. For example, it can be determined whether to terminate reception of service data of a QPS type. In some embodiments, service data having the same type may be service data associated with the same application. For example, it can be determined whether to terminate reception of service data associated with an application A.

In some embodiments, step 204 may further include: determining whether, within a second preset time period after the currently received service data, service data having a type that is the same as that of the currently received service data is received. Moreover step 204 may further include confirming, if no service data having a type that is the same as that of the service data is received within the second preset time period, that the service data server terminates reception of service data having a type that is the same as that of the currently received service data. It is appreciated that if no service data having a type that is the same as that of the currently received service data is received within a particular time period after the service data is currently received, it may be determined that the service data server terminates reception of service data having a type that is the same as that of the currently received service data.

In some embodiments, the second preset time period can be configured according to the configuration unit of the time stamp. For example, if the configuration unit of the time stamp is a second, the second preset time period may be 1 second, 2 seconds, or the like. If the configuration unit of the time stamp is a minute, the second preset time period may be 1 minute, 2 minutes, or the like. By configuring the second preset time period according to the configuration unit of the time stamp, the precision of determining termination of service data reception can be improved. Accordingly, the accuracy of a service data aggregation operation can be improved.

In step 205, if the service data server terminates reception of service data having a type that is the same as that of the currently received service data, data aggregation is performed on the currently received service data. In some embodiments, when the service data server terminates reception of service data having a type that is the same as that of the service data, it indicates that the data aggregation server no longer receives service data of that type. That is, it can no longer be determined, through subsequently receiving service data having the same type, whether a time stamp of service data having that type is changed. In this case, data aggregation can be directly performed on the currently received service data. That way, it can be ensured that if the service data server terminates reception of service data having a type that is the same as that of the currently received service data, data aggregation on the currently received service data can be completed.

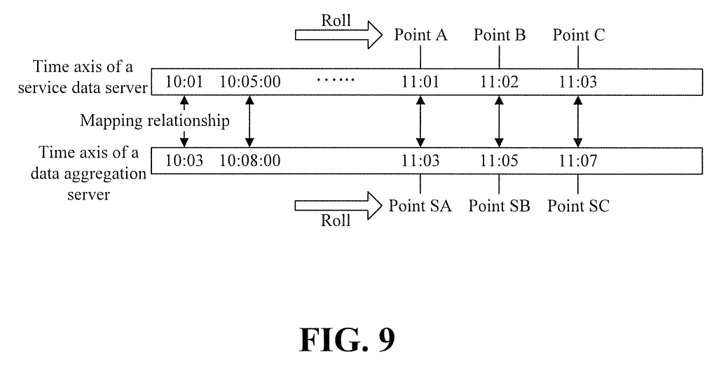

In some embodiments, step 205 may include: acquiring, if the service data server terminates reception of service data having a type that is the same as that of the currently received service data, a local time of the data aggregation server corresponding to a next adjacent time stamp different from the current time stamp. Each different time stamp configured by the service data server respectively corresponds to a local time of the aggregation server. Details of an exemplary configuration is further described below with reference to FIG. 9. Data aggregation can be performed on the currently received service data according to the acquired local time of the data aggregation server. The local time of the data aggregation server can be presented in a chronological manner such as a list, or a time axis. Actual implementation is not limited by the embodiments described herein.

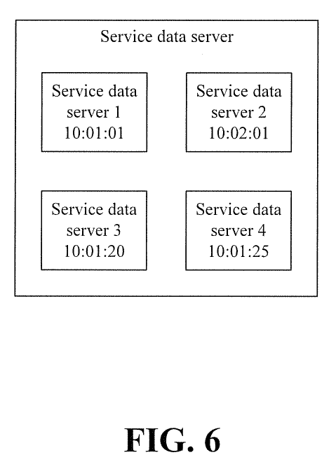

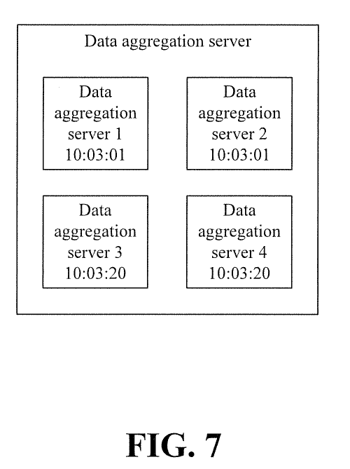

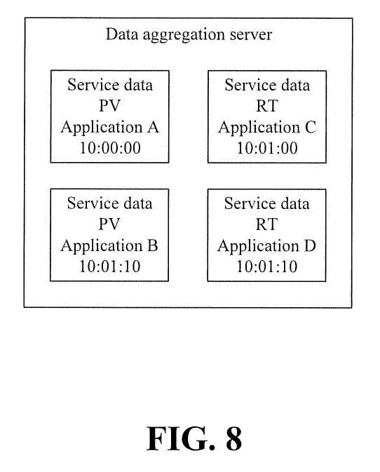

It should be appreciated that due to problems such as network conditions and a time difference between different servers, a corresponding local time of the data aggregation server may be different from a time stamp configured by the service data server. For example, as shown in FIG. 6 and FIG. 7, service data of a service data server 1 is processed by a data aggregation server 1. As shown in FIG. 6, a time stamp configured by the service data server 1 is 10:01:01. The corresponding local time of the data aggregation server 1 as shown in FIG. 7 is 10:03:01. Here the local time of the data aggregation server is different from the corresponding time stamp configured by the service data server. In the data aggregation server, time stamps of different service data associated with the same monitored item and reaching the data aggregation server at the same moment may be different. Further, different monitored items may have different time stamps. For example, as shown in FIG. 8, for service data PV (associated with the same monitored item), at the same moment, a time stamp 10:00:00 of the service data of the application A is different from a time stamp 10:01:10 of the service data of an application B. For service data PV and RT (associated with different monitored items), time stamps of the service data may be different. RT can indicate response time, namely, the total amount of time it takes to respond to a request for service.

In addition, due to reasons associated with service data collection methods, the time at which service data reaches the data aggregation server may be different from the time at which the service data reaches the service data server. For example, as shown in FIG. 9, the time at which service data reaches the service data server is 10:01, and the time at which the service data reaches the data aggregation server is 10:03. Therefore, during real-time data aggregation, the time stamp configured by the service data server can be used as a trigger time, and the local time of the data aggregation server is not used as a trigger time at the same time. That way, the accuracy of data aggregation can be ensured. Moreover, a one-to-one correspondence between each different time stamp configured by the service data server and the local time of the data aggregation server can be established in a chronological manner, so that consistency can be ensured. When the service data server terminates reception of service data having a certain type, by using the local time of the data aggregation server, it can be ensured that the aggregation operation is accurately performed on the service data having that type.

An exemplary implementation scenario is shown in FIG. 9. As shown in FIG. 9, at a point SB on a time axis, the data aggregation server receives service data sent by the service data server. It can be acquired at a moment when a time stamp carried in the service data is 11:02. It can then be detected the time stamp is greater than a time stamp 11:01 carried in service data that is sent by the service data server and is received at a point SA on the time axis, namely, a previous time. In this case, data aggregation can be performed on the service data having the time stamp of 11:01. Further, it can be determined that no service data having a type that is the same type as that of the service data having a time stamp of 11:02 is received within 5 minutes starting from the current time. It can accordingly be determined that the service data server terminates reception of service data having a type that is the same as that of the service data having a time stamp of 11:02. In this case, when the local time of the data aggregation server reaches 11:07 (corresponding to 11:03 of the service data server), data aggregation can be performed on the service data having a time stamp of 11:02. That way, it can be ensured that data aggregation is performed on the service data having a time stamp of 11:02.

According to some embodiments of the present disclosure, when massive service data stored in a cloud environment needs to be aggregated, a data aggregation server first receives service data sent by a service data server. Accordingly, it can be detected in real time whether a time stamp carried in the service data is greater than a time stamp carried in service data that is sent by the service data server and is received by the data aggregation server at a previous time. If the time stamp carried in the service data is greater than the time stamp carried in service data that is sent by the service data server and is received by the data aggregation server at the previous time, data aggregation can be performed on service data having a time stamp that is the same as the time stamp carried in the service data that is sent by the service data server and is received by the data aggregation server at the previous time.

In existing techniques, during the aggregation process of the massive service data stored in the cloud environment, read/write operations need to be performed on the files storing service data. Service data read from the files further needs to be sorted in a chronological order. In addition, if service data corresponding to the same time as or earlier than that of service data on which an aggregation operation is performed is received subsequently, this part of service data will be discarded.

In comparison, according to some embodiments of the present disclosure, to aggregate service data in different time periods, it can be detected whether a time stamp of current service data is greater than the time stamp carried in the service data that is sent by the service data server and is received by the data aggregation server at a previous time. The efficiency of data aggregation can thus be improved. As the detection operation can be performed in real time, a delay of data aggregation operations can be reduced. The real-time performance of data aggregation can be improved. Moreover, because a tolerance time period can be set according to some embodiments of the present disclosure, an aggregation operation can be performed on received service data corresponding to a relatively early time. That way, the precision of data aggregation and statistical analysis can be improved.

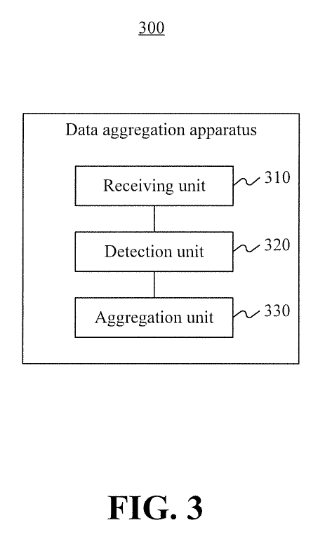

According to some embodiments of the present disclosure, data aggregation apparatuses are further provided. As shown in FIG. 3, an exemplary apparatus 300 includes a receiving unit 310, a detection unit 320, and an aggregation unit 330.

Receiving unit 310 can be configured to receive service data sent by a service data server. The service data carries a time stamp, the time stamp being used to identify the time at which the service server receives the service data.

Detection unit 320 can be configured to detect whether the time stamp received by receiving unit 310 is greater than a target time stamp, the target time stamp being a time stamp carried in service data that is sent by the service data server and is received at a previous time.

Aggregation unit 330 can be configured to perform, if the time stamp detected by detection unit 320 is greater than the target time stamp, data aggregation on service data having a time stamp that corresponds to the target time stamp. The service data corresponding to the target time stamp can be stored at a preset storage location.

For details of the processing performed by receiving unit 310, detection unit 320, and aggregation 330, reference can be made to the above description related to the method embodiments, details of which are not repeated herein. It is appreciated that the apparatus 300 may perform similar processing as those described above in corresponding steps of the method embodiments, for example, the processing as described with reference to FIG. 1.

According to above described embodiments of the present disclosure, when massive service data stored in a cloud environment needs to be aggregated, a data aggregation server first receives service data sent by a service data server, it can be detected in real time whether a time stamp carried in the service data is greater than a time stamp carried in service data that is sent by the service data server and is received by the data aggregation server at a previous time. If the time stamp carried in the service data is greater than the time stamp carried in service data that is sent by the service data server and is received by the data aggregation server at the previous time, data aggregation can be performed on service data having a time stamp that is the same as the time stamp carried in the service data that is sent by the service data server and is received by the data aggregation server at the previous time.

In existing techniques, during the aggregation process of the massive service data stored in the cloud environment, read/write operations need to be performed on the files storing service data. Service data read from the files further needs to be sorted in a chronological order. In addition, if service data corresponding to the same time as or earlier than that of service data on which an aggregation operation is performed is received subsequently, this part of service data will be discarded.

In comparison, according to some embodiments of the present disclosure, to aggregate service data in different time periods, it can be detected whether a time stamp of current service data is greater than the time stamp carried in the service data that is sent by the service data server and is received by the data aggregation server at a previous time. The efficiency of data aggregation can thus be improved. As the detection operation can be performed in real time, a delay of data aggregation operations can be reduced. The real-time performance of data aggregation can be improved.

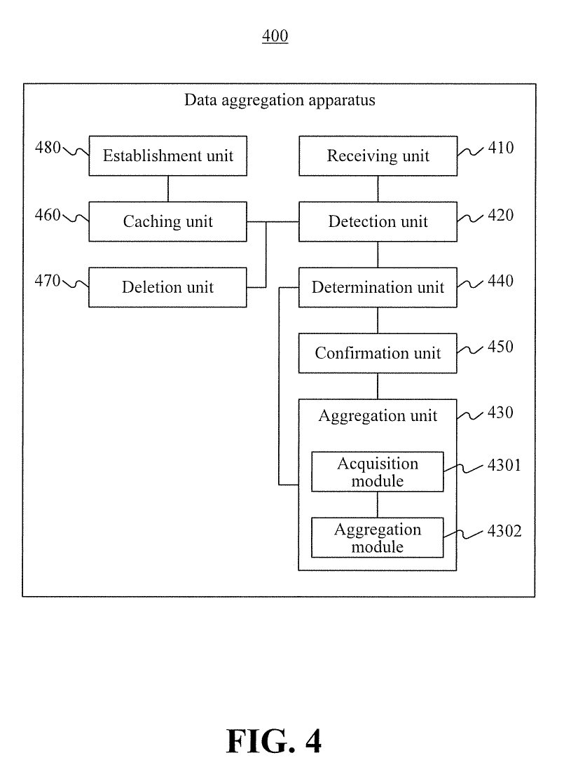

FIG. 4 is a schematic structural diagram of an exemplary data aggregation apparatus 400 according to some embodiments of the present disclosure. As shown in FIG. 4, the apparatus 400 may include a receiving unit 410, a detection unit 420, an aggregation unit 430, a determination unit 440, a confirmation unit 450, a caching unit 460, a deletion unit 470, and an establishment unit 480. Aggregation unit 430 further includes an acquisition module 4301 and an aggregation module 4302.

Receiving unit 410 can be configured to receive service data sent by a service data server. The service data carries a time stamp, the time stamp being used to identify the time at which the service server receives the service data.

Detection unit 420 can be configured to detect whether the time stamp received by receiving unit 410 is greater than a target time stamp, the target time stamp being a time stamp carried in service data that is sent by the service data server and is received at a previous time.

Aggregation unit 430 can be configured to perform, if the time stamp detected by detection unit 420 is greater than the target time stamp, data aggregation on service data having a time stamp that corresponds to the target time stamp. The service data corresponding to the target time stamp can be stored at a preset storage location.

As shown in FIG. 4, apparatus 400 further includes a determination unit 440. Determination unit 440 can be configured to determine whether the service data having a time stamp that corresponds to the target time stamp is received within a first preset time period after the currently received service data.

Aggregation unit 430 can be further configured to perform, if no service data having a time stamp that corresponds to the target time stamp is received within the first preset time period after currently received service data, data aggregation on service data having a time stamp that corresponds to the target time stamp; and perform, if service data having a time stamp that corresponds to the target time stamp is received within the first preset time period after the currently received service data, data aggregation on the service data received within the first preset time period and service data having a time stamp that corresponds to the target time stamp.

In some embodiments, determination unit 440 can be further configured to determine whether the service data server terminates reception of service data having a type that is the same as that of the currently received service data. Aggregation unit 430 can be further configured to perform, if the service data server terminates reception of service data having a type that is the same as that of the service data, data aggregation on the currently received service data.

In some embodiments, apparatus 400 can further include a confirmation unit 450. Determination unit 440 can be configured to determine whether service data having a type that is the same as that of the service data is received within a second preset time period after the currently received service data. Confirmation unit 450 can be configured to confirm, if no service data having a type that is the same as that of the service data is received within the second preset time period, that the service data server terminates reception of service data having a type that is the same as that of the currently received service data.

In some embodiments, aggregation unit 430 may further include an acquisition module 4301 and an aggregation module 4302. Acquisition module 4301 can be configured to acquire, if the service data server terminates reception of service data having a type that is the same as that of the service data, a local time of the data aggregation server corresponding to a next adjacent time stamp different from the current time stamp. Each different time stamp configured by the service data server respectively corresponds to one local time of the data aggregation server. Aggregation module 4302 can be configured to perform data aggregation on the currently received service data according to the acquired local time of the data aggregation server.

In some embodiments, apparatus 400 can further include a caching unit 460 and a deletion unit 470. Caching unit 460 can be configured to cache, if the time stamp is the same as the target time stamp, the currently received service data in a preset queue corresponding to the target time stamp. All service data having a time stamp that corresponds to the target time stamp can be cached in the preset queue. Deletion unit 470 can be configured to delete, if the time stamp is less than the target time stamp, the currently received service data.

In some embodiments, apparatus 400 can further include an establishment unit 480. Establishment unit 480 can be configured to establish a queue corresponding to a time stamp of currently received service data. Caching unit 460 can be further configured to cache the service data in the queue.

For details of the processing performed by the units in apparatus 400 described above, reference can be made to the above description related to the method embodiments, details of which are not repeated herein. It is appreciated that the apparatus 400 may perform similar processing as those described above in corresponding steps of the method embodiments, for example, the processing as described with reference to FIG. 2.

According to above described apparatus embodiments of the present disclosure, when massive service data stored in a cloud environment needs to be aggregated, a data aggregation server first receives service data sent by a service data server, it can be detected in real time whether a time stamp carried in the service data is greater than a time stamp carried in service data that is sent by the service data server and is received by the data aggregation server at a previous time. If the time stamp carried in the service data is greater than the time stamp carried in service data that is sent by the service data server and is received by the data aggregation server at the previous time, data aggregation can be performed on service data having a time stamp that is the same as the time stamp carried in the service data that is sent by the service data server and is received by the data aggregation server at the previous time.

In existing techniques, during the aggregation process of the massive service data stored in the cloud environment, read/write operations need to be performed on the files storing service data. Service data read from the files further needs to be sorted in a chronological order. In addition, if service data corresponding to the same time as or earlier than that of service data on which an aggregation operation is performed is received subsequently, this part of service data will be discarded.

In comparison, according to some embodiments of the present disclosure, to aggregate service data in different time periods, it can be detected whether a time stamp of current service data is greater than the time stamp carried in the service data that is sent by the service data server and is received by the data aggregation server at a previous time. The efficiency of data aggregation can thus be improved. As the detection operation can be performed in real time, a delay of data aggregation operations can be reduced. The real-time performance of data aggregation can be improved. Moreover, because a tolerance time period can be set according to some embodiments of the present disclosure, an aggregation operation can be performed on received service data corresponding to a relatively early time. That way, the precision of data aggregation and statistical analysis can be improved.

It is appreciated that apparatus 400 and the units included therein may be implemented through a processor and a memory. For example, the above described receiving unit 410, detection unit 420, aggregation unit 430, determination unit 440, confirmation unit 450, caching unit 460, deletion unit 470, and establishment unit 480 can be implemented through program instructions stored in the memory. The processor can execute program instructions stored in the memory to perform corresponding functions.

For example, the processor can include a kernel. The kernel can invoke a set of corresponding program instructions from the memory. In some embodiments, one or more kernels may be included. Kernel parameters can be adjusted to facilitate performance of functions corresponding to, for example, the processing described above with respect to the method and apparatus embodiments of the present disclosure. The memory may include, for example, volatile memory, a random-access memory (RAM), or a non-volatile memory in a computer readable medium, such as a read-only memory (ROM) or a flash RAM. The memory may include at least one storage chip.

According to some embodiments of the present disclosure, the technical solutions may be implemented in the form of computer program/software products. When being executed on a data processing device, the computer program product can cause execution of programs corresponding to the method embodiments of the present disclosure. For example, the computer program product can cause execution of the following: receiving, by a data aggregation server, service data sent by a service data server, the service data carrying a time stamp, and the time stamp being used to identify the time at which the service server receives the service data; detecting whether the time stamp is greater than a target time stamp, the target time stamp being a time stamp carried in service data that is sent by the service data server and is received by the data aggregation server at a previous time; and performing, if the time stamp is greater than the target time stamp, data aggregation on service data having a time stamp that corresponds to the target time stamp, the service data corresponding to the target time stamp being stored at a preset storage location.

It is appreciated that the embodiments of the present disclosure may be implemented in the form of a method, a system, or a computer program product. For example, the technical solutions provided herein may be implemented through hardware, software, or a combination thereof. Moreover, the present disclosure may use a form of a computer program product that is implemented through one or more computer-usable storage media that store computer readable program codes. Such computer-usable storage media may include but not limited to a disk memory, a CD-ROM, an optical memory, and the like.

In the foregoing description, exemplary embodiments of the present disclosure are described with reference to the accompanying flowcharts and/or block diagrams of some data aggregation methods, apparatuses, and computer program products according to some embodiments of the present disclosure. It should be appreciated that computer program instructions may be used to implement the processing as shown in the flowcharts and/or the block diagrams. The computer program instructions may be provided for a computer, an embedded processor, or a processor of another programmable data processing device. That way, the corresponding functions described above with reference to the flowcharts and/or in one or more blocks in the block diagrams can be performed.

The computer program instructions may be stored in a computer readable memory that can instruct the computer or the another programmable data processing device to work in a specific manner, so that the instructions stored in the computer readable memory generate a machine that includes the program instructions. The instructions can cause the machine to implement one or more functions as described above with reference to the accompanying flowcharts and/or in one or more blocks in the block diagrams. These computer program instructions may be loaded onto a computer or another programmable data processing device, so that a series of operations and procedures are performed on the computer or the programmable device, thereby generating computer-implemented processing. For example, the instructions executed on the computer or the programmable device can cause performance of functions in one or more processes described above with reference to the flowcharts and/or in one or more blocks in the block diagrams. The above described computer or other computing devices can include one or more processors (CPU), an input/output interface, a network interface, and a memory. The computer readable medium can include a memory. The memory may include a form such as a volatile memory, a RAM and/or a non-volatile memory in a computer readable medium, for example, a ROM or a flash RAM.

Specifically, in some embodiments, the computer readable medium can include a nonvolatile, volatile, removable, or irremovable medium, and may be used to store information. The stored information may be computer readable instructions, data structures, program modules, or other data. An example of a computer storage medium includes, but is not limited to, a phase-change RAM (PRAM), a static RAM (SRAM), a dynamic RAM (DRAM), another type of RAM, a ROM, an electrically erasable programmable ROM (EEPROM), a flash memory or another memory technology, a compact-disc ROM (CD-ROM), a digital versatile disc (DVD) or another optical storage, a cassette tape, a magnetic tape, a magnetic disk storage or another magnetic storage device, NVRM, or any other non-transitory medium, and can be used to store information that can be accessed by a computing device.

It is appreciated that the foregoing descriptions are merely exemplary embodiments of the present disclosure, and do not limit the scope of the present disclosure. Consistent with the present disclosure, those skilled in the art can make various changes and variations to implement technical solutions provided by the present disclosure. Any modifications, equivalent replacements, and improvements made within the spirit and principle of the present disclosure, shall all fall within the scope of present disclosure.

1. A data aggregation method, comprising:
receiving, by a data aggregation server, service data sent by a service data server, the service data carrying a time stamp indicating a time at which the service server receives the service data;
detecting whether the time stamp is greater than a target time stamp, the target time stamp being a time stamp carried in service data received by the data aggregation server at a previous time; and
performing, in response to the time stamp being greater than the target time stamp, data aggregation on service data having a time stamp that corresponds to the target time stamp.

2. The data aggregation method according to claim 1, wherein before performing data aggregation on service data having a time stamp that corresponds to the target time stamp, the method further comprises:
determining whether service data having a time stamp that corresponds to the target time stamp is received within a first preset time period after the currently received service data;
wherein performing data aggregation on service data having a time stamp that corresponds to the target time stamp comprises:
performing, in response to service data having a time stamp that corresponds to the target time stamp not being received within the first preset time period, data aggregation on service data having a time stamp that corresponds to the target time stamp; or
performing, in response to service data having a time stamp that corresponds to the target time stamp being received within the first preset time period, data aggregation on the service data received within the first preset time period and service data having a time stamp that corresponds to the target time stamp.

3. The data aggregation method according to claim 1, wherein after performing data aggregation on service data having a time stamp that corresponds to the target time stamp, the method further comprises:
determining whether the service data server terminates reception of service data of a same type as the currently received service data; and
performing, in response to the service data server terminating reception of service data of the same type as the currently received service data, data aggregation on the currently received service data.

4. The data aggregation method according to claim 3, wherein determining whether the service data server terminates reception of service data of the same type as the currently received service data comprises:
determining whether service data of the same type as the currently received service data is received within a second preset time period after the currently received service data; and
determining, in response to service data not of the same type as the currently received service data being received within the second preset time period, that the service data server terminates reception of service data of the same type as the currently received service data.

5. The data aggregation method according to claim 3, wherein performing, in response to the service data server terminating reception of service data of the same type as the currently received service data, data aggregation on the currently received service data comprises:
acquiring, a local time of the data aggregation server corresponding to a next adjacent time stamp different from the current time stamp; and
performing data aggregation on the currently received service data according to the local time of the data aggregation server.

6. The data aggregation method according to claim 1, wherein after detecting whether the time stamp is greater than the target time stamp, the method further comprises:
caching, in response to the time stamp being the same as the target time stamp, the currently received service data in a preset queue corresponding to the target time stamp; or
deleting, in response to the time stamp being less than the target time stamp, the currently received service data.

7. The data aggregation method according to claim 1, wherein after performing data aggregation on service data having a time stamp that corresponds to the target time stamp, the method further comprises:
establishing a queue corresponding to a time stamp of the currently received service data; and
caching the service data in the queue.

8. A data aggregation apparatus, comprising:
a memory storing a set of instructions; and
a processor configured to execute the set of instructions to cause the apparatus to perform:
receiving service data sent by a service data server, the service data carrying a time stamp indicating a time at which the service server receives the service data;
detecting whether the time stamp is greater than a target time stamp, the target time stamp being a time stamp carried in service data received at a previous time; and
performing, if the time stamp is greater than the target time stamp, data aggregation on service data having a time stamp that corresponds to the target time stamp.

9. The data aggregation apparatus according to claim 8, wherein before performing data aggregation on service data having a time stamp that corresponds to the target time stamp, the processor is further configured to execute the set of instructions to cause the apparatus to perform:
determining whether service data having a time stamp that corresponds to the target time stamp is received within a first preset time period after the currently received service data;
wherein performing data aggregation on service data having a time stamp that corresponds to the target time stamp comprises:
performing, in response to service data having a time stamp that corresponds to the target time stamp not being received within the first preset time period, data aggregation on service data having a time stamp that corresponds to the target time stamp; and
performing, in response to service data having a time stamp that corresponds to the target time stamp being received within the first preset time period, data aggregation on the service data received within the first preset time period and service data having a time stamp that corresponds to the target time stamp.

10. The data aggregation apparatus according to claim 8, wherein after performing data aggregation on service data having a time stamp that corresponds to the target time stamp, the processor is further configured to execute the set of instructions to cause the apparatus to perform:
determining whether the service data server terminates reception of service data of a same type as the currently received service data; and
performing, if the service data server terminates reception of service data of the same type as the currently received service data, data aggregation on the currently received service data.

11. The data aggregation apparatus according to claim 10, wherein determining whether the service data server terminates reception of service data of the same type as the currently received service data comprises:
determining whether service data of the same type as the currently received service data is received within a second preset time period after the currently received service data; and
determining, if service data not of the same type as the currently received service data is received within the second preset time period, that the service data server terminates reception of service data of the same type as the currently received service data.

12. The data aggregation apparatus according to claim 10, wherein performing, if the service data server terminates reception of service data of the same type as the currently received service data, data aggregation on the currently received service data comprises:
acquiring, a local time of a data aggregation server corresponding to a next adjacent time stamp different from the current time stamp; and
performing data aggregation on the currently received service data according to the local time of the data aggregation server.

13. The data aggregation apparatus according to claim 8, wherein after detecting whether the time stamp is greater than the target time stamp, the processor is further configured to execute the set of instructions to cause the apparatus to perform:
caching, if the time stamp is the same as the target time stamp, the currently received service data in a preset queue corresponding to the target time stamp; and
deleting, if the time stamp is less than the target time stamp, the currently received service data.

14. (canceled)

15. A non-transitory computer readable medium that stores a set of instructions that is executable by at least one processor of a computer to cause the computer to perform a method, the method comprising:
receiving, by a data aggregation server, service data sent by a service data server, the service data carrying a time stamp indicating a time at which the service server receives the service data;
detecting whether the time stamp is greater than a target time stamp, the target time stamp being a time stamp carried in service data received at a previous time; and
performing, if the time stamp is greater than the target time stamp, data aggregation on service data having a time stamp that corresponds to the target time stamp.

16. The non-transitory computer readable medium according to claim 15, wherein before performing data aggregation on service data having a time stamp that corresponds to the target time stamp, the set of instructions that is executable by the at least one processor of the computer causes the computer to further perform:
determining whether service data having a time stamp that corresponds to the target time stamp is received within a first preset time period after the currently received service data;
wherein performing data aggregation on service data having a time stamp that corresponds to the target time stamp comprises:
performing, in response to service data having a time stamp that corresponds to the target time stamp not being received within the first preset time period, data aggregation on service data having a time stamp that corresponds to the target time stamp; and
performing, in response to service data having a time stamp that corresponds to the target time stamp being received within the first preset time period, data aggregation on the service data received within the first preset time period and service data having a time stamp that corresponds to the target time stamp.

17. The non-transitory computer readable medium according to claim 15, wherein after performing data aggregation on service data having a time stamp that corresponds to the target time stamp, the set of instructions that is executable by the at least one processor of the computer causes the computer to further perform:
determining whether the service data server terminates reception of service data of a same type as the currently received service data; and
performing, if the service data server terminates reception of service data of the same type as the currently received service data, data aggregation on the currently received service data.

18. The non-transitory computer readable medium according to claim 17, wherein determining whether the service data server terminates reception of service data of the same type as the currently received service data comprises:
determining whether service data of the same type as the currently received service data is received within a second preset time period after the currently received service data; and
determining, if service data not of the same type as the currently received service data is received within the second preset time period, that the service data server terminates reception of service data of the same type as the currently received service data.

19. The non-transitory computer readable medium according to claim 17, wherein performing, if the service data server terminates reception of service data of the same type as the currently received service data, data aggregation on the currently received service data comprises:
acquiring, a local time of the data aggregation server corresponding to a next adjacent time stamp different from the current time stamp; and
performing data aggregation on the currently received service data according to the local time of the data aggregation server.

20. The non-transitory computer readable medium according to claim 15, wherein after detecting whether the time stamp is greater than the target time stamp, the set of instructions that is executable by the at least one processor of the computer causes the computer to further perform:
caching, if the time stamp is the same as the target time stamp, the currently received service data in a preset queue corresponding to the target time stamp; and
deleting, if the time stamp is less than the target time stamp, the currently received service data.

21. The non-transitory computer readable medium according to claim 15, wherein after performing data aggregation on service data having a time stamp that corresponds to the target time stamp, the set of instructions that is executable by the at least one processor of the computer causes the computer to further perform:
establishing a queue corresponding to a time stamp of the currently received service data; and
caching the service data in the queue.
